(19) United States
(12) Patent Application Publication
(10) Pub. No.: US 2007/0041046 A1
(43) Pub. Date: Feb. 22, 2007

(54) Network printing system and data processing method using the same

(75) Inventors: Seung-soo Lee, Suwon-si (KR); Seong-kyoo Park, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/500,897

(22) Filed: Aug. 9, 2006

(30) Foreign Application Priority Data
Aug. 16, 2005 (KR) 2005-74723

(51) Int. Cl. G06F 3/12

(52) U.S. Cl. 358/1.15; 358/1.14

(57) ABSTRACT

A method of processing data in a network printing system having a network printer and at least one host computer connected thereto, the method including adding an address list of a host computer that is designated as allowed to print through the network printer to predetermined document data according to a selection of a user, determining whether an address, which is identical to that of the host computer, exists in the address list when a command to print the document data is input, and printing the document data if the address, which is identical to that of the host computer, is determined to exist in the address list.

### CROSS-REFERENCE TO RELATED APPLICATIONS

This application claims the benefit of Korean Patent Application No. 2005-74723, filed Aug. 16, 2005, in the Korean Intellectual Property Office, the disclosure of which is incorporated herein by reference.

### BACKGROUND OF THE INVENTION

1. Field of the Invention

Aspects of the present invention relate to a data processing apparatus and a control method thereof which prints document data in a network printing system comprising a network printer and a host computer, and, more particularly, to a data processing apparatus which uses address information of a host computer to print document data for purposes of security, and a control method thereof.

2. Description of the Related Art

In a conventional network printing system comprising a network printer and at least one host computer connected to the network printer, if a certain host computer commands that a printing operation occur, printing data is transmitted to the network printer. Then, the network printer prints all the received printing data.

However, conventional network printing systems generally do not have printing limitation function for security documents and, therefore, management of such security documents may be troublesome.

In this regard, Korean Patent Application No. 1999-42200 discloses a method of securely managing a network printer which solves the security problem by requiring an input of a predetermined password when a host computer issues a command that a printing operation should occur. Similarly, Korean Patent Application No. 1999-39754 discloses a method for managing printing security of a network printer which allows a printing operation if only an IP address of a host computer is registered to maintain the security of the printing.

However, neither of the above-mentioned Korean patent applications provide for a variation of a range of security grades of the document data within the host computer that is allowed to issue a command to initiate the printing operation. That is, according to the above-mentioned Korean Patent Applications, the security grade may be set to allow the document data to be printed only by position, department or company, and not according to the kind of the document data being printed.

Accordingly, a data processing apparatus and a control method thereof, which designates a host computer for printing documents by document data in a network printing system is required.

### SUMMARY OF THE INVENTION

Accordingly, it is an aspect of the present invention to provide a network printing system which sets the range of a host computer allowed to print by document data and a data processing method in the network printing system.

The foregoing and/or other aspects of the present invention are also achieved by providing a method of processing data in a network printing system having a network printer and at least one host computer connected thereto, the method comprising adding an address list of a host computer that is designated as allowed to print through the network printer to predetermined document data according to a selection of a user, determining whether an address, which is identical to that of the host computer, exists in the address list when a command to print the document data is input, and printing the document data if the address, which is identical to that of the host computer, is determined to exist in the address list.

According to another aspect of the present invention, the adding of the address list of the host computer comprises adding the address list of the host computer when the document data is generated.

According to another aspect of the present invention, the adding the address list of the host computer comprises activating an address input window through which the address of the host computer printing the document data is input; inputting the address of the host computer through the address input window; and adding the input address to the document data.

According to another aspect of the present invention, the determining comprises determining through the host computer.

According to another aspect of the present invention, the method further comprises generating printing data based on the document data and transmitting the printing data to the network printer if the address, identical to that of the host computer, exists in the address list.

According to another aspect of the present invention, the method further comprises informing a user that printing is impossible through a display part provided in the host computer if the address, identical to that of the host computer, does not exist in the address list.

The foregoing and/or other aspects of the present invention are also achieved by providing a method of processing data using a host computer which is connected to a network printer, the method comprising: receiving a printing command to print predetermined document data from a user; determining whether the document data comprises an address list; determining whether an address, which is identical to that of the host computer, exists in the address list when the document data comprises the address list; and generating printing data based on the document data if the address, which is identical to that of the host computer, is determined to exist in the address list.

According to another aspect of the present invention, the method further comprises transmitting the generated printing data to the network printer.

According to another aspect of the present invention, the method further comprises informing a user that printing is impossible through a display part provided in the host computer when the address, identical to that of the host computer, does not exist in the address list.

The foregoing and/or other aspects of the present invention are also achieved by providing a method of processing data using a network printer which is connected to at least one host computer, the method comprising: receiving printing data from a host computer; determining whether the printing data comprises an address list; determining whether an address, which is identical to that of the host computer, exists in the address list when the printing data comprises the address list; and printing the printing data if the address, which is identical to that of the host computer, is determined to exist in the address list.

According to another aspect of the present invention, the method further comprises informing a user that printing is impossible through the host computer if the address, identical to that of the host computer, does not exist in the address list.

The foregoing and/or other aspects of the present invention are also achieved by providing a host computer which is connected to a printer through a network, comprising: an address list generator which generates an address list comprising an address of at least one host computer which his designated as being allowed to print documents through the printer; and an address list adding part which adds the address list generated by the address list generator to predetermined document data.

According to another aspect of the present invention, the host computer further comprises an address list checker which checks whether the document data printed by a printing command of a user comprises the address list; a comparison determiner which determines to print the document data if the address of the host computer exists in the address list; and a printing data generator which generates printing data based on the document data according to determination of a comparison determiner.

The foregoing and/or other aspects of the present invention are also achieved by providing a host computer which is connected to a printer through a network, comprising an address list checker which checks whether document data printed by a printing command of a user comprises an address list; a comparison determiner which determines to print the document data if an address of the host computer exists in the address list; and a printing data generator which generates printing data based on the document data according to the determination of the comparison determiner.

The foregoing and/or other aspects of the present invention are also achieved by providing a printer which is connected with a host computer through a network, comprising an address list checker which checks whether printing data received from the host computer comprises an address list; a comparison determiner which determines to print the printing data if an address of the host computer is included in the address list; and a printing part which prints the printing data according to the determination of the comparison determiner.

The foregoing and/or other aspects of the present invention are also achieved by providing a network printing system which comprises a host computer and a printer connected to the host computer through a network.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a network printing system according to a first embodiment of the present invention;

FIG. 2 is a detailed block diagram of a host computer in FIG. 1;

FIG. 3 illustrates an example of a displaying state of the host computer in FIG. 2;

FIG. 4 illustrates the process of generating document data according to the first embodiment of the present invention;

FIG. 5 illustrates the process of processing the document data according to the first embodiment of the present invention;

FIG. 6 is a detailed block diagram of a host computer of a network printing system according to a second embodiment of the present invention;

FIG. 7 is a detailed block diagram of a network printer of the network printing system according to the second embodiment of the present invention; and

FIG. 8 illustrates the process of processing printing data according to the second embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

### First Embodiment

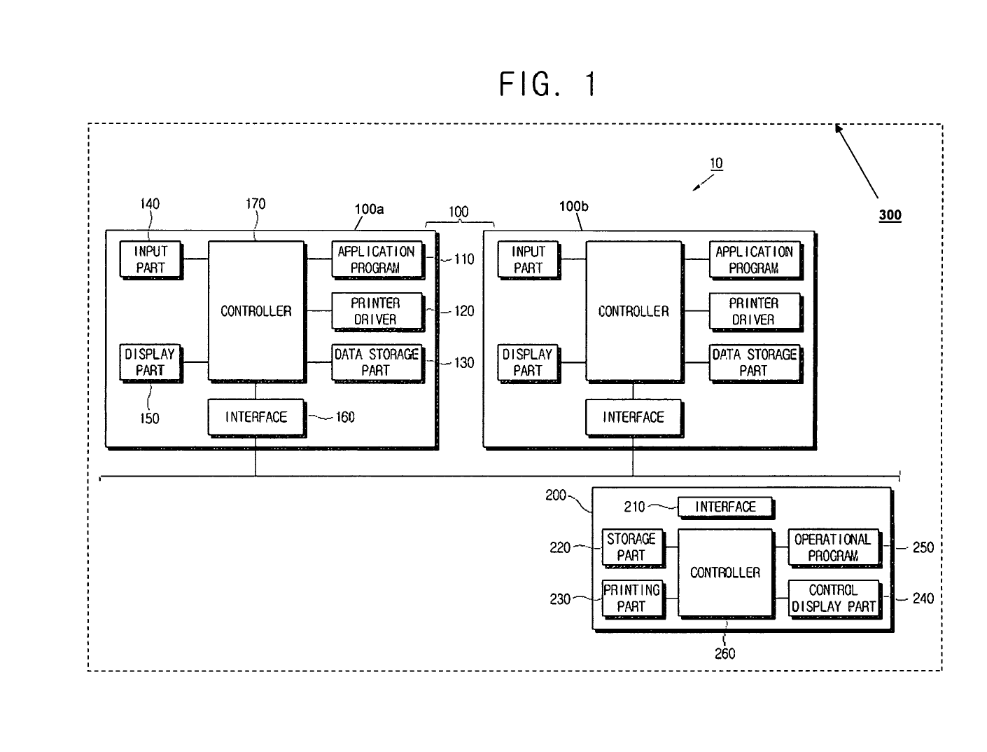

As shown in FIG. 1, a network printing system 10, according to a first embodiment of the present invention, comprises a plurality of host computers 100, including host computer 100a and host computer 100b, a network printer 200 which is connected to the host computers 100, and a Local Area Network (LAN) 300 which connects the host computers 100 to each other and to the network printer 200.

Each host computer 100a and 100b comprises an application program 110 to generate document data, a printer driver 120 to print the document data, and a data storage part 130 to store the document data. Here, the application program 110, the printer driver 120 and the data storage part 130 are stored in a storage (not shown) of each of the host computers 100a and 100b. The storage comprises a HDD, a ROM, RAM and/or a combination thereof.

Each host computer 100a and 100b further comprises an input part 140 comprising a keyboard and a mouse, a display part 150 to display an operational state of the host computers 100, an interface 160 to be connected to the LAN 300, and a controller 170 to control operations of the foregoing elements of each of the host computers 100a and 100b.

The document data stored in the data storage part 130 of each of the host computers 100a and 100b is activated by the application program 110. The printer driver 120 is called by a printing command of a user of each of the host computers 100a and 100b through the application program 110 to generate printing data based on the document data. The generated printing data is transmitted to the network printer 200 through the interface 160.

The network printer 200 comprises an interface 210 to be connected to the LAN 300, a storage part 220 to store the printing data received from the interface 210, a printing part 230 to print the printing data onto a recording medium (i.e. paper, transparency, etc.), a control display part 240 to display an operational state of the network printer 200 and to receive a command of the user, and a controller 260 to control the interface 210, the printing part 230, and the control display part 240. The network printer 200 further comprises an operational program 250 through which the controller 260 controls operations of the network printer 200. The operational program 250 may be stored in the storage part 220.

The printing data received from each of the host computers 100a and 100b through the LAN 300 is stored in the storage part 220. The controller 260 controls the printing part 230 based on the printing data to print the document.

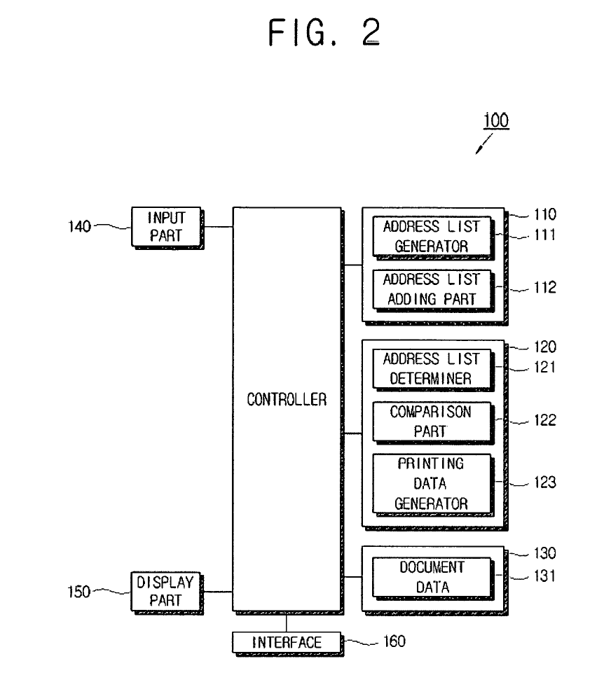

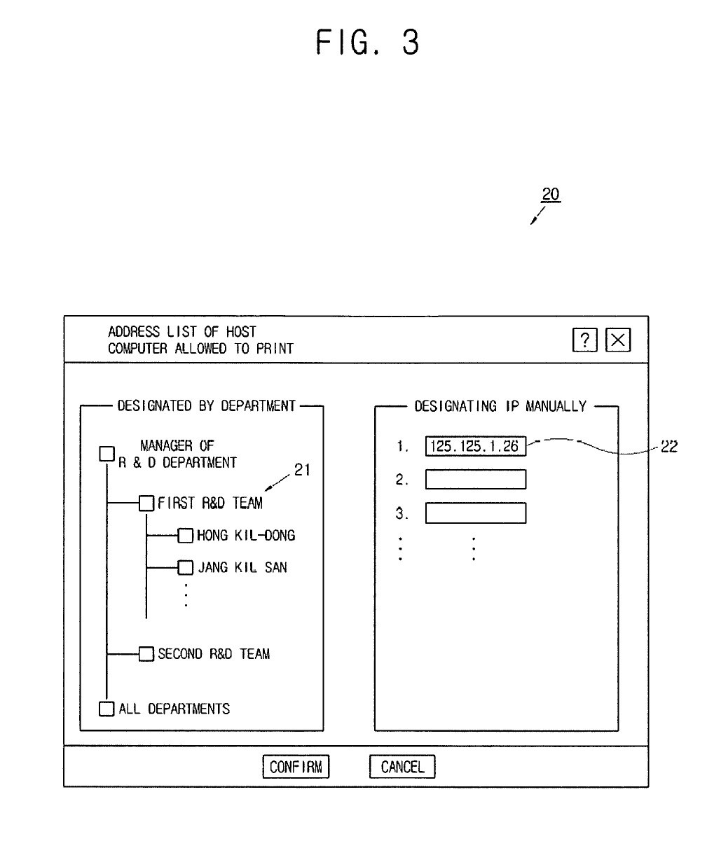

As shown in FIG. 2, each host computer 100a and 100b further comprises an address list generator 111 and an address list adding part 112 which are both provided in the application program 110 of each host computer 100a and 100b. The address list generator 111 of each host computer 100a and 100b displays an activation window 20 (refer to FIG. 3) on the display part 150 of the corresponding host computer 100a or 100b to allow for an input of an address list comprising an Internet Protocol (IP) address (hereinafter, referred to as “address”) of the corresponding host computer 100a or 100b. The address list adding part 112 adds the address list to the currently-activated document data 131.

With the address list added to the data 131, the address list is used to designate the host computer 100a or 100b as being allowed to print the concerned printing data 131. That is, the host computer 100a or 100b (assume host computer 100a), whose address is included in the address list, is designated as being allowed to print the concerned document data 131. Conversely, the host computer 100a or 100b (assume host computer 100b), whose address is not included in the address list, is not designated as being allowed to print the concerned document data 131.

As shown in FIG. 3, the display part 150 displays the activation window 20 thereon by an execution of the address list generator 111. The host computer 100a, designated as being allowed to print the document data 131, may be designated by a respective department (refer to a left side in FIG. 3) in which the host computer 100a sits. For example, if a first R&D Team 21 is designated, since the host computer 100a is used in the first R&D Team 21, the host computer 100a is designated as being allowed to print the document data 131. Alternatively, the address of the host computer 100a, which is designated as being allowed to print, may be directly input (refer to a right side in FIG. 3). For example, the address of the host computer 100a including an identification of a certain user who is allowed to print may be input in an input box 22.

If the input of the address list is completed through the address list generator 111, the address list is added to the document data 131 by the address list adding part 112. The document data 131, including the added address list, may be copied, moved or removed like other computer files.

As shown in FIG. 2, the printer driver 120 comprises an address list checker 121, a comparison determiner 122 and a printing data generator 123. The address list checker 121 checks whether the document data 131, acting as a base to generate the printing data by the printer driver 120, comprises the address list. If it is determined that the document data 131 does not comprise the address list, the printing data generator 123 generates the printing data based on the document data 131.

If the document data 131 comprises the address list, the comparison determiner 122 checks the document data 131 and the address list of the host computer 100 being executed by the printer driver 120. Then, the comparison determiner 122 determines whether an address, which is identical to that of the checked host computer 100a, is included in the address list.

If it is determined that an address identical to that of the host computer 100a exists in the address list, the comparison determiner 122 calls the printing data generator 123 to generate the printing data based on the document data 131. Conversely, if it is determined that an address identical to that of the host computer 100a does not exist in the address list, the printer driver 120 does not allow the printing data to be generated and informs a user that the printing is impossible, through the display part 150.

Hereinafter, an embodiment of the data processing method using the network printing system having the foregoing configuration will be described.

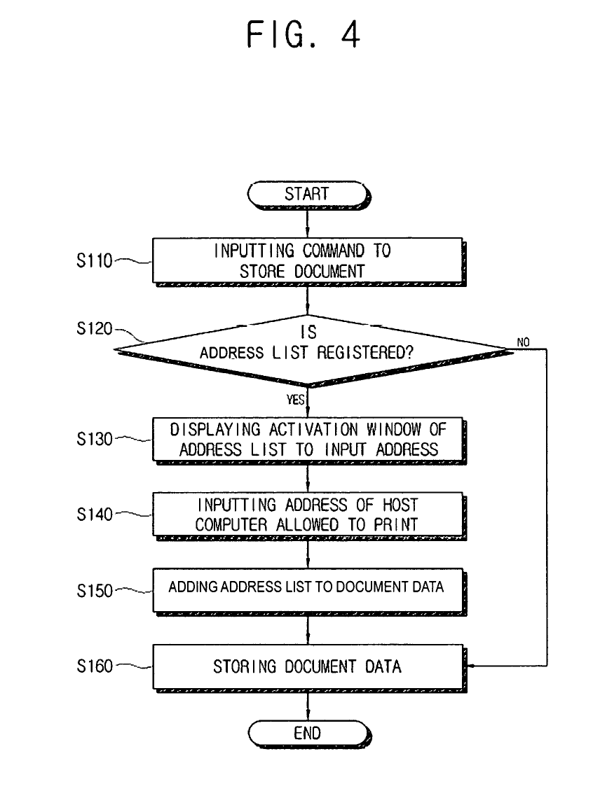

FIG. 4 illustrates a process of adding the address list to the document data. First, the application program 110 receives a command to store the document from a user where the document data 131 and the application program 110 are activated on the display part 150 at operation S110. When the storing command is input, the application program 110 displays a window to allow for a checking of whether to input the address list on the display part 150 at operation S120. If a user inputs the address list, the activation window 20 of FIG. 3 is displayed on the display part 150 to allow for an input of the address at operation S130. A user then designates or inputs the address of the host computer 100a that is to be designated as being allowed to print the document data 131 through the activation window 20 at operation S140. If the input of the address list is completed, the application program 110 adds the address list to the document data 131 to store the address together with the document data 131 at operation S160.

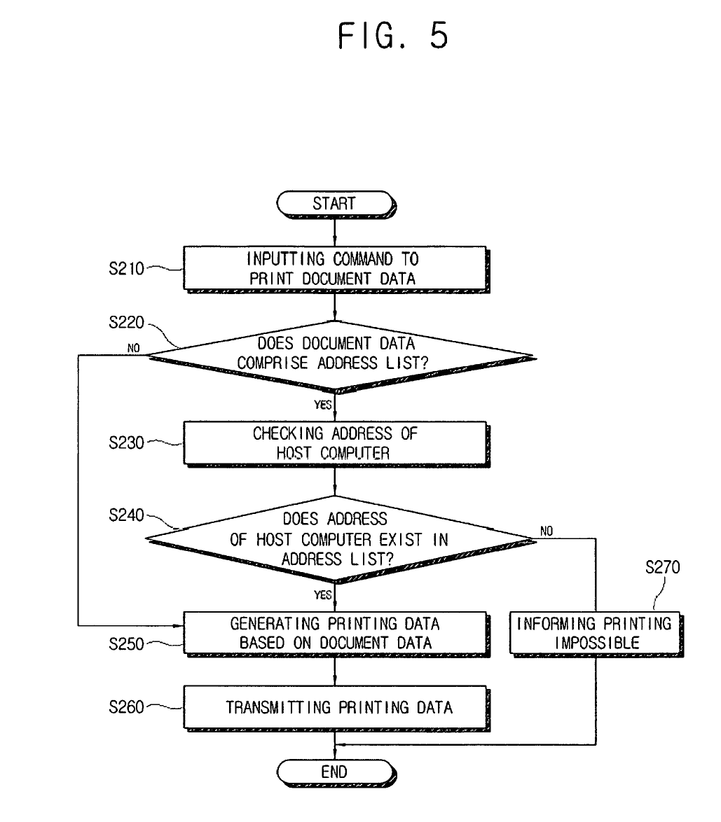

FIG. 5 illustrates an operation of the printer driver 120 according to a printing command of the document data 131. The process may be performed by the host computer 100a which generates the document data 131 or other host computers (i.e., host computer 100b) receiving the document data 131 through an e-mail, etc.

First, the host computer 100a receives the printing command of the document data 131 through the application program 110 at operation S210. The printer driver 120 is called by the input of the printing command and determines whether the document data 131 comprises the address list at operation S220 through the address list determiner 121.

If it is determined that the address list is not included therein, the printer driver 120 generates the printing data based on the concerned document data 131 at operation S250, and transmits the printing data to the network printer 200 at operation S260. Meanwhile, if it is determined that the document data 131 comprises the address list, the address of the host computer 100a, whose printer driver 120 is currently tasked to operate, is checked at operation S230. The comparison part 122 determines whether the address of the host computer 100 exists in the address list at operation S240. If it is determined that the address of the host computer 100 does not exist in the address list, the printer driver 120 informs a user that the printing is impossible through the display part 150 at operation 270 to complete a printing operation. If, however, it is determined that the address of the host computer 100 exists in the address list, the printing data generator 123 generates the printing data based on the document data 131 at operation S250. The generated printing data is transmitted to the network printer 200 at operation S260.

Meanwhile, the address list generator 111 and the address list adding part 112 in FIG. 2 may be included in other programs or may exist as an independent program, instead of being included in the application program 110. Also, the address list checker 121 and the comparison determiner 122 may be included in other programs or may exist as an independent program, instead of being included in the printer driver 120.

### Second Embodiment

A network printing system according to a second embodiment of the present invention is similar to that the network printing system illustrated in FIG. 1, except that a host computer 400, which is connected to the LAN 300 (refer to FIG. 1) and a network printer 500 are different from those of the embodiment in FIG. 1.

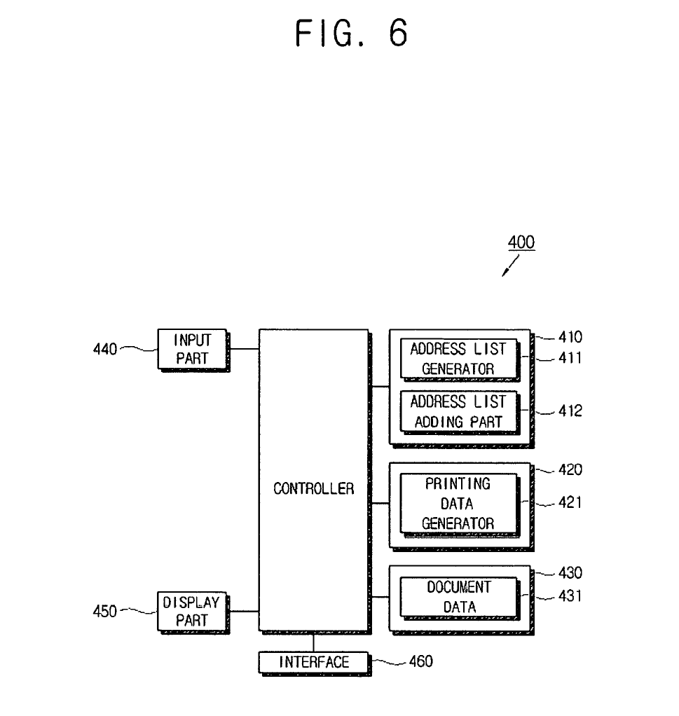

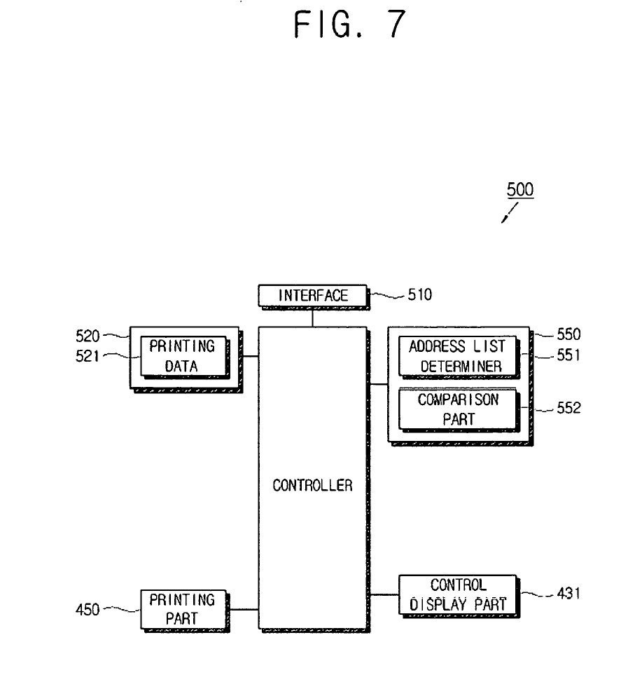

As shown in FIGS. 6 and 7, an application program 410 of the host computer 400 comprises an address list generator 411 and an address list adding part 412. An application program 550 of the network printer 500 comprises an address list checker 551 and a comparison determiner 552. Accordingly, the address list added to document data 431 through the application program 410 of the host computer 400 may be checked and processed by the network printer 500.

As shown in FIG. 6, if a user inputs a command to print the document data 431 from the host computer 400, a printer driver 420 generates printing data 521 based on the document data 431. At this time, the address list, which is included in the document data 431, comprises a header file to be included in the printing data 521.

As shown in FIG. 7, the network printer 500 receives the printing data 521 from the host computer 400 through an interface 510 to store the printing data in a storage part 520. Then, the address list determiner 551 of the application program 550 checks whether the printing data 521 comprises the address list. If it is determined that the printing data 521 does not comprise the address list, a printing part 530 prints the printing data 521 according to a control of a controller 560.

If the printing data 521 is determined to comprise the address list, the comparison determiner 552 checks the address of the host computer 400, transmitting the printing data 521, and determines whether an address which is identical to that of the host computer 400 is included in the address list.

If it is determined that the address, which is identical to that of the host computer 400, exists in the address list, the controller 560 controls the printing part 530 to print the printing data 521. Conversely, if it is determined that the address, which is identical to that of the host computer 400 does not exist in the address list, the controller 560 controls the display part 450 of the host computer 400 to inform a user that the printing is impossible.

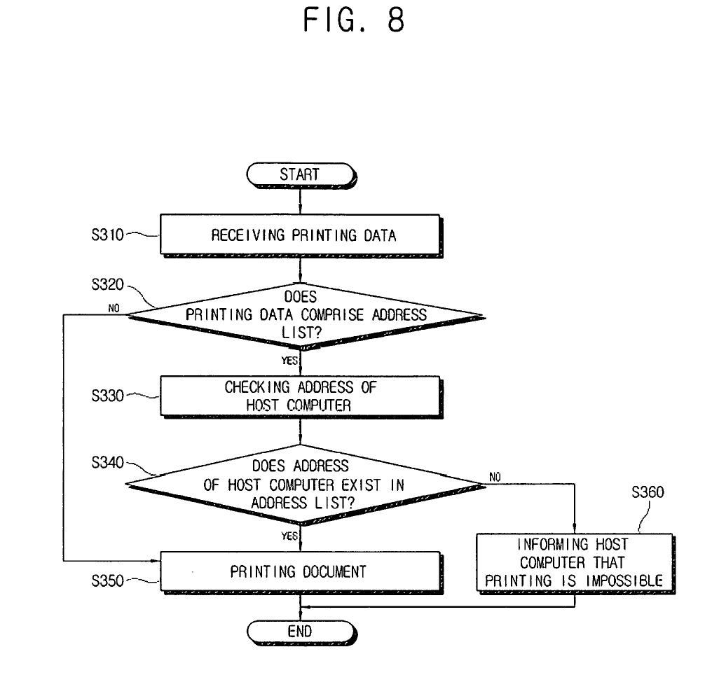

FIG. 8 illustrates an operation of the network printer 500. As shown, the printing data 521, transmitted to the network printer 500, may be transmitted from the host computer 400 generating the printing data 521 or from other host computers 400 receiving the printing data 521 through an e-mail, etc. First, the network printer 500 receives the printing data 521 transmitted from the host computer 400 at operation S310, and temporarily stores the printing data in the storage part 520.

Then, the address list checker 551 checks whether the printing data 521 comprises the address list at operation S320. If it is determined that the printing data 521 does not comprise the address list, the controller 560 controls the printing part 530 to print the concerned printing data 521 at operation S350. If it is determined that the printing data 521 comprises the address list, the address of the host computer 400 transmitting the printing data 521 is checked at operation S330. Then, the comparison determiner 552 determines whether the address of the host computer 400 exists in the address list at operation S340. If it is determined that the address of the host computer 400 does not exist in the address list, the printer driver 420 informs a user that the printing is impossible through the display part 450 of the host computer 400 at operation S360 to complete a printing operation. If it is determined that the address of the host computer 400 exists in the address list, the controller 560 controls the printing part 530 to print the concerned printing data 521 at operation S350.

Of course, it is understood that the above-mentioned methods may be embodied by a computer readable medium on which a program is stored to execute the methods. Such a computer readable medium may be a hard disk, an optical disk (i.e., blu-ray, HD-DVD), etc., or a combination thereof.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of processing data in a network printing system having a network printer and at least one host computer connected thereto, the method comprising:
adding an address list of a host computer that is designated as allowed to print through the network printer to predetermined document data according to a selection of a user;
determining whether an address, which is identical to that of the host computer, exists in the address list when a command to print the document data is input; and
printing the document data if the address, which is identical to that of the host computer, is determined to exist in the address list.

2. The method according to claim 1, wherein the adding of the address list of the host computer comprises adding the address list of the host computer when the document data is generated.

3. The method according to claim 2, wherein the adding of the address list of the host computer comprises:
activating an address input window through which the address of the host computer printing the document data is input;
inputting the address of the host computer through the address input window; and
adding the input address to the document data.

4. The method according to claim 1, wherein the determining comprises determining whether the address exists in the address list through the host computer.

5. The method according to claim 4, further comprising:
generating printing data based on the document data; and
transmitting the printing data to the network printer if the address, which is identical to that of the host computer, is determined to exist in the address list.

6. The method according to claim 4, further comprising informing a user that printing is impossible through a display part provided in the host computer if the address, which is identical to that of the host computer, is determined to not exist in the address list.

7. A method of processing data using a host computer which is connected to a network printer, the method comprising:
receiving a printing command to print predetermined document data from a user;
determining whether the document data comprises an address list;
determining whether an address, which is identical to that of the host computer, exists in the address list when the document data comprises the address list; and
generating printing data based on the document data if the address, which is identical to that of the host computer, is determined to exist in the address list.

8. The method according to claim 7, further comprising transmitting the generated printing data to the network printer.

9. The method according to claim 7, further comprising informing a user that printing is impossible through a display part provided in the host computer where the address, which is identical to that of the host computer, is determined to not exist in the address list.

10. A method of processing data using a network printer which is connected to at least one host computer, the method comprising:
receiving printing data from a host computer;
determining whether the printing data comprises an address list;
determining whether an address, which is identical to that of the host computer, exists in the address list when the printing data comprises the address list; and
printing the printing data if the address, which is identical to that of the host computer, is determined to exist in the address list.

11. The method according to claim 10, further comprising informing a user that printing is impossible through the host computer if the address, which is identical to that of the host computer, is determined to not exist in the address list.

12. A host computer which is connected to a printer through a network, comprising:
an address list generator which generates an address list comprising an address of the host computer which is designated as being allowed to print documents through the printer; and
an address list adding part which adds the address list generated by the address list generator to predetermined document data.

13. The host computer according to claim 12, further comprising:
an address list checker which checks whether the document data printed by a printing command of a user comprises the address list;
a comparison determiner which determines that a printing of the document data should proceed if the address of the host computer exists in the address list; and
a printing data generator which generates printing data based on the document data according to the determination of the comparison determiner.

14. A host computer which is connected to a printer through a network, comprising:
an address list checker which checks whether document data printed by a printing command of a user comprises an address list;
a comparison determiner which determines that a printing of the document data should proceed if an address of the host computer exists in the address list; and
a printing data generator which generates printing data based on the document data according to the determination of the comparison determiner.

15. A printer which is connected with a host computer through a network, comprising:
an address list checker which checks whether printing data received from the host computer comprises an address list;
a comparison determiner which determines that a printing of the printing data should proceed if an address of the host computer is included in the address list; and
a printing part which prints the printing data according to the determination of the comparison determiner.

16. A method of processing data in a network printing system in which a host computer prints documents on a network printer, the method comprising:
inputting a command to print document data at the host computer;
determining whether the document data includes an address list;
if the document data includes the address list, checking an address of the host computer, and determining whether the address of the host computer exists in the address list;
if the address of the host computer exists in the address list, generating printing data based on the document data; and
transmitting the printing data to the network printer.

17. The method according to claim 16, wherein, if the document data does not include the address list, the method further comprises:
generating the printing data based on the document data; and
transmitting the printing data to the network printer.

18. The method according to claim 16, wherein, if the address of the host computer does not exist in the address list, the method further comprises informing a user that printing is impossible.

19. A method of processing data in a network printing system in which a host computer prints documents on a network printer, the method comprising:
receiving printing data from the host computer;
determining whether the printing data includes an address list;
if the printing data includes an address list, checking an address of the host computer, and determining whether the address of the host computer exists in the address list; and
if the address of the host computer exists in the address list, printing the printing data.

20. The method according to claim 19, wherein, if the printing data does not include an address list, printing the printing data.

21. The method according to claim 19, wherein, if the address of the host computer does not exist in the address list, the method further comprises informing the host computer that printing is impossible.

22. A computer readable medium have a program stored thereon to execute the method according to claim 1.

23. A computer readable medium have a program stored thereon to execute the method according to claim 7.

24. A computer readable medium have a program stored thereon to execute the method according to claim 10.

25. A computer readable medium have a program stored thereon to execute the method according to claim 16.

26. A computer readable medium have a program stored thereon to execute the method according to claim 19.
